(19) United States
(12) Patent Application Publication
(10) Pub. No.: US 2022/0152731 A1
(43) Pub. Date: May 19, 2022

(54) LASER PROCESSING APPARATUS

(71) Applicant: FUJIKURA LTD., Tokyo (JP)

(72) Inventors: Yuji Matsuoka, Chiba (JP); Akira Sakamoto, Chiba (JP)

(73) Assignee: FUJIKURA LTD., Tokyo (JP)

(21) Appl. No.: 17/434,303

(22) PCT Filed: Mar. 10, 2020
(86) PCT No.: PCT/JP2020/010186

§ 371 Date: Aug. 26, 2021

(30) Foreign Application Priority Data
Mar. 11, 2019 (JP) 2019-043452

(51) Int. Cl. B23K 26/0622; B23K 26/06; B23K 26/70

(52) U.S. Cl. CPC B23K 26/0622; B23K 26/0648; G02B 6/0288; B23K 26/705; B23K 26/0604

(57) ABSTRACT

A laser processing apparatus includes a process laser light source, a first optical system, a pulse laser light source, a second optical system, and an optical detection portion. The process laser light source generates a process laser beam having a continuous energy density during a certain period of time. The first optical system directs the process laser beam to a surface of a workpiece. The pulse laser light source generates a pulse laser beam having an energy density with a peak value that is higher than the energy density of the process laser beam. The second optical system directs the pulse laser beam to a process portion of the workpiece. The optical detection portion detects plasma light produced at the process portion of the workpiece.

### CROSS-REFERENCE TO RELATED APPLICATIONS

This is a national phase application of International Patent Application No. PCT/JP2020/010186 filed Mar. 10, 2020, which claims priority to Japanese Patent Application No. 2019-043452, filed on Mar. 11, 2019. The full contents of these applications are incorporated herein by reference.

### TECHNICAL FIELD

The present invention relates to a laser processing apparatus, and more particular to a laser processing apparatus that directs a laser beam to a workpiece to process the workpiece.

### BACKGROUND

When a laser beam is directed to a workpiece to process the workpiece, vapor (plume) is generated during the processing. When the laser beam passes through the generated plume, the plume is overheated so as to produce plasma light. It has been known that such plasma light varies depending on the process conditions and the process state at that time. Therefore, measurement of plasma light produced during processing a workpiece allows the process conditions and the process state at that time to be grasped, thereby determining the quality of the laser processing or providing a feedback for the laser processing.

Many laser processing apparatuses that direct a laser beam to a workpiece to process the workpiece employ a fiber laser or a YAG laser as a laser light source (see, e.g., Patent Literature 1). The wavelength of a laser beam generated by such a laser light source is shorter than the wavelength of a laser beam generated by a carbon dioxide gas laser (10.6 μm). Laser beams having such a short wavelength are unlikely to be absorbed into ionized plume. Therefore, a small amount of plasma light is produced during the processing. Thus, it is difficult to grasp the process conditions and the process state accurately from the plasma light.

### PATENT LITERATURE

Patent Literature 1: JP 2018-144085 A

### SUMMARY

One or more embodiments of the present invention describe a laser processing apparatus that enables process conditions or a process state to be grasped with accuracy.

According to one or more embodiments of the present invention, there is provided a laser processing apparatus that enables process conditions or a process state to be grasped with accuracy. The laser processing apparatus has a process laser light source operable to generate a process laser beam having a continuous energy density during a certain period of time, a first optical system that directs the process laser beam to a surface of a workpiece, a pulse laser light source operable to generate a pulse laser beam having an energy density with a peak value that is higher than the energy density of the process laser beam, a second optical system that directs the pulse laser beam to a process portion of the workpiece, and an optical detection portion operable to detect plasma light produced at the process portion of the workpiece.

### BRIEF DESCRIPTION OF DRAWINGS

FIG. 1 is a schematic diagram showing an overall configuration of a laser processing apparatus according to one or more embodiments of the present invention.

FIG. 2 is a graph showing a temporal variation of outputs of laser beams used in the laser processing apparatus illustrated in FIG. 1.

FIG. 3 is a graph showing an example of a temporal variation in intensity of plasma light detected in the laser processing apparatus illustrated in FIG. 1.

FIG. 4 is a schematic view showing an overall configuration of a laser processing apparatus according to one or more embodiments of the present invention.

FIG. 5 is a schematic view showing an overall configuration of a laser processing apparatus according to one or more embodiments of the present invention.

FIG. 6 is a schematic cross-sectional view showing a configuration of a third optical fiber in the laser processing apparatus illustrated in FIG. 5.

### DETAILED DESCRIPTION

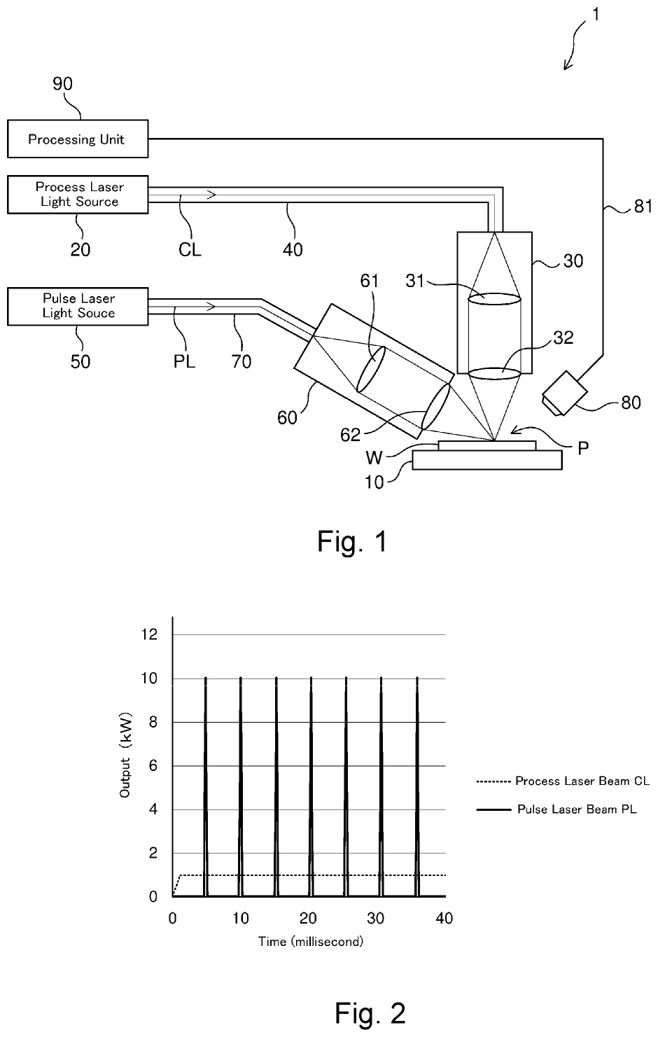

Embodiments of a laser processing apparatus according to the present invention will be described in detail below with reference to FIGS. 1 to 6. In FIGS. 1 to 6, the same or corresponding components are denoted by the same or corresponding reference numerals and will not be described below repetitively. Furthermore, in FIGS. 1 to 6, the scales or dimensions of components may be exaggerated, or some components may be omitted.

FIG. 1 is a schematic diagram showing an overall configuration of a laser processing apparatus 1 according to one or more embodiments of the present invention. As shown in FIG. 1, the laser processing apparatus 1 of one or more embodiments has a stage 10 that holds a workpiece W thereon, a process laser light source 20 operable to generate a process laser beam CL, a first laser emission portion 30 for directing the process laser beam CL to a surface of the workpiece W, a first optical fiber 40 that connects between the process laser light source 20 and the first laser emission portion 30, a pulse laser light source 50 operable to generate a pulse laser beam PL, a second laser emission portion 60 for directing the pulse laser beam PL to a process portion P of the workpiece W, a second optical fiber 70 that connects between the pulse laser light source 50 and the second laser emission portion 60, and an optical detection portion 80 operable to detect plasma light produced at the process portion P of the workpiece W. As used herein, the term “process portion” refers to a process point on a surface of the workpiece W being processed by the process laser beam CL and a space including the vicinity of the process point.

For example, a fiber laser or a YAG laser can be used for the process laser light source 20. The process laser beam CL generated by the process laser light source 20 is what is called a continuous wave (CW) laser beam and has a continuous energy density during at least a certain period of time (e.g., 10 milliseconds) as shown in FIG. 2. The process laser beam CL propagates through a core of the first optical fiber 40 and enters the first laser emission portion 30.

The first laser emission portion 30 includes a collimator lens 31 that collimates the process laser beam CL and a condenser lens 32 that focuses the process laser beam CL that has been collimated by the collimator lens 31 to a surface of the workpiece W. Those lenses 31 and 32 form a first optical system that directs the process laser beam CL to the surface of the workpiece W. Thus, the process laser beam CL having a high energy density is directed to the surface of the workpiece W, so that the temperature of the surface of the workpiece W increases. The workpiece W is then melted or evaporated to implement processing such as welding or cutting.

For example, a fiber laser or a YAG laser can be used for the pulse laser light source 50. The pulse laser beam PL generated by the pulse laser light source 50 is a pulsed beam having a pulse width of several tens of nanometers and a repetition frequency of about 100 Hz, for example, as shown in FIG. 2. The peak value of the energy density of the pulse laser beam PL is higher than the energy density of the process laser beam CL at that point of time. In the example illustrated in FIG. 2, the peak value of the output of the pulse laser beam PL is about 10 kW, and the average output of the process laser beam CL is about 1 kW.

The second laser emission portion 60 includes a collimator lens 61 that collimates the pulse laser beam PL and a condenser lens 62 that focuses the pulse laser beam PL that has been collimated by the collimator lens 61 to a specific point in the process portion P of the workpiece W. Those lenses 61 and 62 form a second optical system that directs the pulse laser beam PL to the process portion P of the workpiece W. The focal point of the condenser lens 62 may be located at a process point on the surface of the workpiece W or may be located near the process point. In order to increase the intensity of plasma light as described below, the focal point of the condenser lens 62 maybe be disposed within a plume produced from the surface of the workpiece W by irradiation of the process laser beam CL (for example, at a height of several millimeters to 50 mm from the surface of the workpiece W).

When the surface of the workpiece W is irradiated with the process laser beam CL, high-temperature metal vapor (plume) is produced at the process point of the workpiece W. When the laser beam transmits through the plume, the plume is overheated to produce plasma light. It has been known that the intensity of the plasma light varies depending on process conditions and a process state, such as variations in power of the process laser beam CL, a state of an assist gas, dirtiness of the surface of the workpiece W, compositional changes of the material being processed, variations of a gap between junctions being processed, and the like. Therefore, the current process conditions and process state can be grasped by detection of changes in intensity of the plasma light, thereby making it possible to determine the quality of the laser processing and provide a feedback for the laser processing.

The optical detection portion 80 is used to detect such plasma light. For example, the optical detection portion 80 includes any known optical sensor operable to detect visible light. The optical detection portion 80 is connected to a processing unit 90 by a signal line 81. The processing unit 90 is operable to determine the current process conditions and process state from the intensity of plasma light detected by the optical detection portion 80 and, optionally, to determine the quality of the laser processing or change an output of the process laser beam CL generated by the process laser light source 20.

As described above, in one or more embodiments, the pulse laser beam PL having an energy density with a peak value that is higher than the energy density of the process laser beam CL is directed to the process portion P of the workpiece W. The intensity of plasma light produced from a plume is in proportion to the amount of the produced plume and an energy density of light transmitting through the plume. Therefore, the intensity of plasma light produced from the plume can be increased by irradiating the process portion P (plume) of the workpiece W with the pulse laser beam PL having a high energy density. Accordingly, detection of the plasma light by the optical detection portion 80 is facilitated so that changes in intensity of the plasma light can be detected with higher accuracy. Furthermore, the pulse laser beam PL is directed to the process portion P (plume) independently of the process laser beam CL. Therefore, even when parameters for the process laser beam CL are varied according to the process conditions, changes in intensity of the plasma light can be detected more accurately by the optical detection portion 80 without influences from the varied parameters for the process laser beam CL. As a result, the current process conditions and process state can be grasped with higher accuracy.

The peak value of the energy density of the pulse laser beam PL is higher than the energy density of the process laser beam CL at that point of time. Since the pulse laser beam PL is a pulse wave having a short pulse width, the pulse laser beam PL exerts less influence on the surface (process point) of the workpiece W. In other words, a time-integrated value of the output of the pulse laser beam PL (average output) is less than a time-integrated value of the output of the process laser beam CL (average output) as illustrated in FIG. 2. Therefore, the pulse laser beam PL exerts less influence on the surface (process point) of the workpiece W. From this point of view, for example, an output of the pulse laser beam PL per unit time may be adjusted to be lower than a tenth of an output of the process laser beam CL per unit time.

The peak value of the energy density of the pulse laser beam PL may be held constant. When the peak value of the energy density of the pulse laser beam PL is held constant, the energy density of the pulse laser beam PL directed to the plume is continuously held constant even when the energy density of the process laser beam CL is varied according to the process conditions. Accordingly, changes in intensity of the plasma light can be detected more accurately by the optical detection portion 80 without influences from the varied energy density of the process laser beam CL.

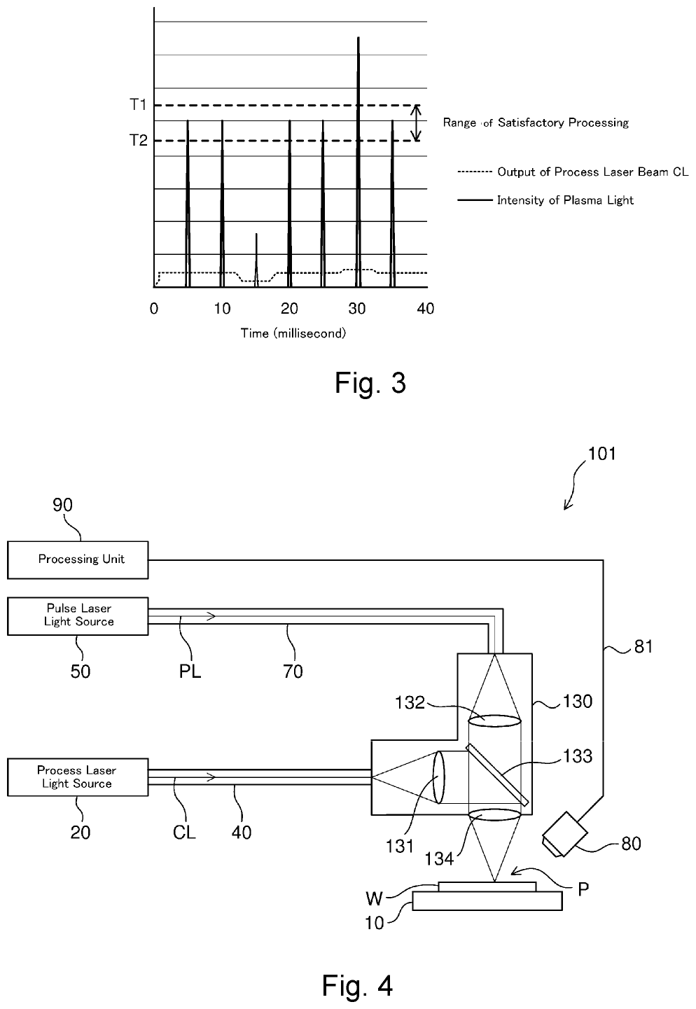

For example, the following method may be employed to determine the quality of laser processing using the intensity of the plasma light. As shown in FIG. 3, an upper limit T1 and a lower limit T2 for the intensity of plasma light to be detected by the optical detection portion 80 are preset and stored in a storage device within the processing unit 90. The processing unit 90 compares the intensity of plasma light detected by the optical detection portion 80 to the upper limit T1 and the lower limit T2, respectively, and determines that processing is being conducted satisfactorily if the intensity of plasma light detected by the optical detection portion 80 is between the upper limit T1 and the lower limit T2. On the other hand, if the intensity of plasma light detected by the optical detection portion 80 is greater than the upper limit T1 or smaller than the lower limit T2, the processing unit 90 determines that the processing is not being conducted satisfactorily and, for example, may change the parameters for the process laser beam CL to be generated by the process laser light source 20.

FIG. 4 is a schematic diagram showing an overall configuration of a laser processing apparatus 101 according to one or more embodiments of the present invention. The laser processing apparatus 101 of one or more embodiments has a single laser emission portion 130 instead of the first laser emission portion 30 and the second laser emission portion 60 of one or more aforementioned embodiments. The laser emission portion 130 is connected to the process laser light source 20 and the pulse laser light source 50 by a first optical fiber 40 and a second optical fiber 70, respectively.

The laser emission portion 130 includes a collimator lens 131 that collimates the process laser beam CL, a collimator lens 132 that collimates the pulse laser beam PL, a mirror 133, and a condenser lens 134. The mirror 133 is provided as a dichroic mirror configured to reflect light having a wavelength of the process laser beam CL but transmit light having a wavelength of the pulse laser beam PL.

The condenser lens 134 is configured to focus the process laser beam CL that has been collimated by the collimator lens 131 and reflected on the mirror 133 to a surface of the workpiece W and to focus the pulse laser beam PL that has been collimated by the collimator lens 132 and transmitted through the mirror 133 to a specific point in the process portion P of the workpiece W. The position of the collimator lens 132 can be adjusted to focus the pulse laser beam PL to the process point on the surface of the workpiece W or near the process point (plume). Furthermore, an F value of the collimator lens 132 can relatively be increased to enhance the energy density of the pulse laser beam PL to be focused by the condenser lens 134.

Thus, according to one or more embodiments, the collimator lens 131, the mirror 133, and the condenser lens 134 form a first optical system that directs the process laser beam CL to the surface of the workpiece W, whereas the collimator lens 132, the mirror 133, and the condenser lens 134 form a second optical system that directs the pulse laser beam PL to the process portion P of the workpiece W. In other words, the condenser lens 134 is common to the first optical system and the second optical system. Thus, the number of required optical components can be decreased, and a simple configuration can be implemented.

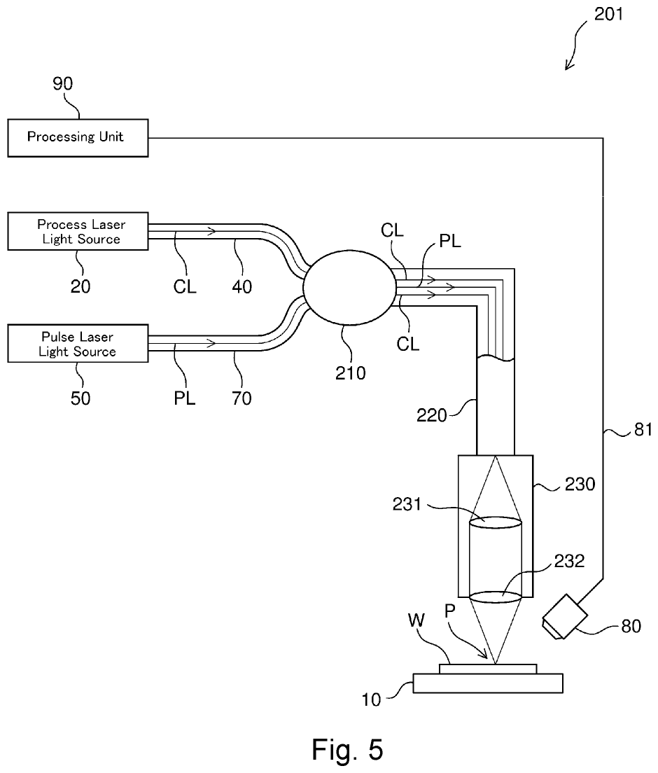

FIG. 5 is a schematic diagram showing an overall configuration of a laser processing apparatus 201 according to one or more embodiments of the present invention. The laser processing apparatus 201 of one or more embodiments has an optical combiner 210 connected to the first optical fiber 40 and the second optical fiber 70, a third optical fiber 220 extending from the optical combiner 210, and a laser emission portion 230 connected to the third optical fiber 220, instead of the laser emission portion 130 of one or more embodiments.

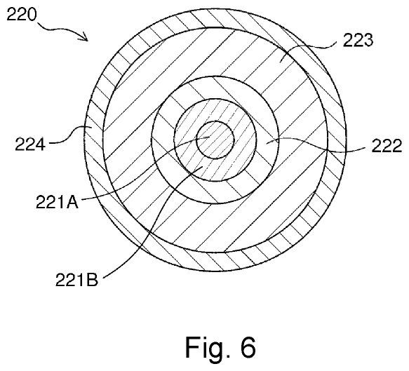

The optical combiner 210 is operable to combine the process laser beam CL propagating through a core of the first optical fiber 40 and the pulse laser beam PL propagating through a core of the second optical fiber 70 with each other and output the combined beam to the third optical fiber 220. For example, as shown in FIG. 6, the third optical fiber 220 comprises a double-clad fiber including an inner core 221A, an outer core 221B located around the inner core 221A with a refractive index lower than a refractive index of the inner core 221A, an inner cladding 222 located around the outer core 221B with a refractive index lower than the refractive index of the outer core 221B, an outer cladding 223 located around the inner cladding 222 with a refractive index lower than the refractive index of the inner cladding 222, and a covering 224 that covers a circumference of the outer cladding. For example, the inner core 221A has a diameter of 30 pm, and the outer core 221B has a diameter of 50 μm.

The laser emission portion 230 includes a collimator lens 231 that collimates the process laser beam CL and the pulse laser beam PL and a condenser lens 232 that focuses the process laser beam CL and the pulse laser beam PL. Thus, according to one or more embodiments, the collimator lens 231 and the condenser lens 232 form a shared optical system, which serves as both of a first optical system that directs the process laser beam CL to the surface of the workpiece W and a second optical system that directs the pulse laser beam PL to the process portion P of the workpiece W. With use of such a shared optical system, the number of required optical components can be decreased, and a simple configuration can be implemented.

The configuration of connection between the optical combiner 210 and the third optical fiber 220 is not limited to a specific one. For example, the pulse laser beam PL outputted from the optical combiner 210 may be coupled to the inner core 221A of the third optical fiber 220, and the process laser beam CL outputted from the optical combiner 210 may be coupled to the outer core 221B of the third optical fiber 220. Alternatively, the process laser beam CL may be coupled to the inner cladding 222 of the third optical fiber 220. Thus, since the pulse laser beam PL is coupled to the inner core 221A of the third optical fiber 220, the pulse laser beam PL having a high energy density can be transmitted to the laser emission portion 230, so that the energy density of the pulse laser beam PL to be to be focused by the condenser lens 134 can be enhanced. Therefore, the pulse laser beam PL having a high energy density can be directed to the process portion P (plume) of the workpiece W. Accordingly, the intensity of plasma light produced from the plume can be increased. Thus, detection of the plasma light by the optical detection portion 80 is facilitated so that changes in intensity of the plasma light can be detected with higher accuracy.

Particularly, the inner core 221A of the third optical fiber 220 may be able to transmit single-mode light or few-mode light. In the case where the pulse laser beam PL is coupled to the inner core 221A through which a small number of modes propagate, the peak value of the energy density of the pulse laser beam PL is prevented from being lowered during which the pulse laser beam PL propagates through the inner core 221A. Therefore, the pulse laser beam PL having a high energy density can be directed to the process portion P (plume) of the workpiece W. There is another advantage that the pulse width of the pulse laser beam PL is unlikely to increase.

In this case, the pulse laser beam PL may have a wavelength that is shorter than a wavelength of the process laser beam CL. For example, the process laser beam CL may have a wavelength of 1070 nm, and the pulse laser beam PL may have a wavelength of 800 nm to 900 nm. With this configuration, chromatic aberration of the condenser lens 232 can be utilized to direct the process laser beam CL to the surface of the workpiece W and to direct the pulse laser beam PL to the plume, which is located above the surface of the workpiece W.

Although some embodiments of the present invention have been described, the present invention is not limited to the aforementioned embodiments. It should be understood that various different forms may be applied to the present invention within the technical idea thereof.

As described above, according to one or more embodiments of the present invention, there is provided a laser processing apparatus that enables process conditions or a process state to be grasped with accuracy. The laser processing apparatus has a process laser light source operable to generate a process laser beam having a continuous energy density during a certain period of time, a first optical system that directs the process laser beam to a surface of a workpiece, a pulse laser light source operable to generate a pulse laser beam having an energy density with a peak value that is higher than the energy density of the process laser beam, a second optical system that directs the pulse laser beam to a process portion of the workpiece, and an optical detection portion operable to detect plasma light produced at the process portion of the workpiece.

In this manner, since the pulse laser beam having an energy density with a peak value that is higher than the energy density of the process laser beam is directed to the process portion (plume) of the workpiece, the intensity of plasma light produced from the plume can be increased. Thus, detection of the plasma light by the optical detection portion is facilitated so that changes in intensity of the plasma light can be detected with higher accuracy. Furthermore, the pulse laser beam is directed to the process portion (plume) independently of the process laser beam. Therefore, even when parameters for the process laser beam are varied according to process conditions, changes in intensity of the plasma light can be detected more accurately by the optical detection portion without influences from the varied parameters for the process laser beam. As a result, the current process conditions and process state can be grasped with higher accuracy.

The second optical system may focus the pulse laser beam to a plume portion produced when the process laser beam is directed to the surface of the workpiece. With this configuration, the intensity of plasma light produced at the plume portion can be increased.

The peak value of the energy density of the pulse laser beam may be constant. When the peak value of the energy density of the pulse laser beam is held constant, the energy density of the pulse laser beam directed to the plume is continuously held constant even when the energy density of the process laser beam is varied according to the process conditions. Accordingly, changes in intensity of the plasma light can be detected more accurately by the optical detection portion without influences from the varied energy density of the process laser beam.

An output of the pulse laser beam per unit time may be lower than a tenth of an output of the process laser beam per unit time. This configuration allows the pulse laser beam to exert less influence on the surface of the workpiece.

The first optical system and the second optical system may use at least one lens in common. Since at least one lens is used in common by the first optical system and the second optical system, the number of required optical components can be decreased, and a simple configuration can be implemented.

The laser processing apparatus may further include a first optical fiber connected to the process laser light source, a second optical fiber connected to the pulse laser light source, a shared optical system that functions as both of the first optical system and the second optical system, a third optical fiber connected to the shared optical system, and an optical combiner operable to combine the process laser beam from the first optical fiber and the pulse laser beam from the second optical fiber with each other and output the combined beam to the third optical fiber. Since the shared optical system is used for propagation of the process laser beam and the pulse laser beam, the number of required optical components can be decreased while a simple configuration can be implemented.

The third optical fiber may include an inner core through which the pulse laser beam propagates, an outer core covering a circumference of the inner core and having a refractive index lower than a refractive index of the inner core, and a cladding covering a circumference of the outer core and having a refractive index lower than the refractive index of the outer core. Furthermore, the inner core of the third optical fiber may be capable of transmitting single-mode light or few-mode light. Thus, the pulse laser beam is coupled to the inner core through which a small number of modes propagate. Therefore, the peak value of the energy density of the pulse laser beam is prevented from being lowered during which the pulse laser beam propagates through the inner core. Accordingly, the pulse laser beam having a high energy density can be transmitted to the shared optical system. Consequently, the pulse laser beam having a high energy density can be directed to the process portion of the workpiece, so that the intensity of plasma light produced from the plume can be increased. In this manner, detection of the plasma light by the optical detection portion is facilitated so that changes in intensity of the plasma light can be detected with higher accuracy.

The pulse laser beam may have a wavelength shorter than a wavelength of the process laser beam. Particularly, when the pulse laser beam has a wavelength shorter than a wavelength of the process laser beam in a case where the aforementioned shared optical system is used, chromatic aberration of the lens in the shared optical system can be utilized to direct the process laser beam to the surface of the workpiece and to direct the pulse laser beam to the plume, which is located above the surface of the workpiece.

According to one or more embodiments of the present invention, the intensity of plasma light produced from plume can be increased. Thus, detection of the plasma light by the optical detection portion is facilitated so that changes in intensity of the plasma light can be detected more accurately by the optical detection portion without influences from the varied parameters for the process laser beam. As a result, the current process conditions and process state can be grasped with higher accuracy.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### DESCRIPTION OF REFERENCE NUMERALS AND SIGNS

1 Laser processing apparatus

10 Stage

20 Process laser light source

30 First laser emission portion

31 Collimator lens

32 Condenser lens

40 First optical fiber

50 Pulse laser light source

60 Second laser emission portion

61 Collimator lens

62 Condenser lens

70 Second optical fiber

80 Optical detection portion

90 Processing unit

101 Laser processing apparatus

130 Laser emission portion

131, 132 Collimator lens

133 Mirror

134 Condenser lens

201 Laser processing apparatus

210 Optical combiner

220 Third optical fiber

221A Inner core

221B Outer core

222 Inner cladding

223 Outer cladding

224 Covering

230 Laser emission portion

231 Collimator lens

232 Condenser lens

P Process portion

W Workpiece

CL Process laser beam

PL Pulse laser beam

1. A laser processing apparatus comprising:
a process laser light source that generates a process laser beam having a continuous energy density during a certain period of time;
a first optical system that directs the process laser beam to a surface of a workpiece;
a pulse laser light source that generates a pulse laser beam having an energy density with a peak value that is higher than the energy density of the process laser beam;
a second optical system that directs the pulse laser beam to a process portion of the workpiece; and
an optical detection portion that detects plasma light produced at the process portion of the workpiece.

2. The laser processing apparatus as recited in claim 1, wherein the process laser beam, when directed to the surface of the workpiece, produces a plume portion, and the second optical system focuses the pulse laser beam to the plume portion.

3. The laser processing apparatus as recited in claim 1, wherein the peak value of the energy density of the pulse laser beam is constant.

4. The laser processing apparatus as recited in claim 1, wherein an output of the pulse laser beam per unit time is lower than one tenth of an output of the process laser beam per unit time.

5. The laser processing apparatus as recited in claim 1, wherein the first optical system and the second optical system use at least one lens in common.

6. The laser processing apparatus as recited in claim 1, further comprising:
a first optical fiber connected to the process laser light source;
a second optical fiber connected to the pulse laser light source;
a shared optical system that functions as both of the first optical system and the second optical system;
a third optical fiber connected to the shared optical system; and
an optical combiner that combines the process laser beam from the first optical fiber and the pulse laser beam from the second optical fiber with each other and outputs a combined beam to the third optical fiber.

7. The laser processing apparatus as recited in claim 6, wherein the third optical fiber comprises:
an inner core through which the pulse laser beam propagates,
an outer core covering a circumference of the inner core and having a refractive index lower than a refractive index of the inner core, and
a cladding covering a circumference of the outer core and having a refractive index lower than the refractive index of the outer core.

8. The laser processing apparatus as recited in claim 7, wherein the inner core of the third optical fiber is capable of transmitting single-mode light or few-mode light.

9. The laser processing apparatus as recited in claim 1, wherein the pulse laser beam has a wavelength shorter than a wavelength of the process laser beam.

10. The laser processing apparatus as recited in claim 6, wherein the shared optical system focuses the pulse laser beam to a plume portion produced when the process laser beam is directed to the surface of the workpiece.

11. The laser processing apparatus as recited in claim 6, wherein the peak value of the energy density of the pulse laser beam is constant.

12. The laser processing apparatus as recited in claim 6, wherein an output of the pulse laser beam per unit time is lower than one tenth of an output of the process laser beam per unit time.

13. The laser processing apparatus as recited in claim 6, wherein the shared optical system uses at least one lens.

14. The laser processing apparatus as recited in claim 6, wherein the pulse laser beam has a wavelength shorter than a wavelength of the process laser beam.
